(19) United States
(12) Patent Application Publication
(10) Pub. No.: US 2008/0278819 A1
(43) Pub. Date: Nov. 13, 2008

(54) Adjustable screen

(76) Inventor: Dalton B. Rickets, Etobicoke (CA)

Correspondence Address: D.W. EGGINS, 18 DOWNSVIEW DRIVE, BARRIE, ON, L4M 4P8, CA

(21) Appl. No.: 11/797,923

(22) Filed: May 9, 2007

(51) Int. Cl. G02B 27/00

(52) U.S. Cl. 359/601; 359/608

(57) ABSTRACT

A screening device limits the access of light to a viewing reference surface such as a computer screen. The device has a substantially opaque screening portion of predetermined size and form; and adjustable mounting means for attaching it. The device may have a shaped spine portion rotatably and slidably inserted in a mounting trough, which trough can be adhered to a support surface, such as the cabinet of a computer screen. Three such devices can form a hood about the top and sides of a screen. There are simple, non-adjustable embodiments. Use with a cell phone is contemplated.

### CROSS REFERENCE TO RELATED APPLICATIONS

Not Applicable (N/A)

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. This invention is directed to adjustable screen means, and in particular to screen means for screening incident and reflected light from impinging upon a viewing screen such as a computer monitor or other device.

2. Widespread use is currently made of computers, where users frequently spend many hours working in front of the monitor of the machine. The impingement on the monitor screen of bright incident light, as from lamps and/or room illumination and daylight, adversely affect the visibility of the screen contents. Indirectly, owing to the close proximity of the user to the monitor, light that originates from a source behind the monitor and illuminates the front of the user can be readily reflected upon the screen of the monitor to the extent of virtually precluding effective viewing of the contents of the screen. Thus light both directly and indirectly incident upon a monitor screen can adversely affect the viewing of the contents of that screen.

### BRIEF SUMMARY OF THE INVENTION

The present invention provides detachable screen means that may be mounted on the cabinet of a monitor such as a computer screen, to moderate the impingement of incident and reflected light upon the screen.

In order to enhance usage of the system under conditions that may vary from time to time, a preferred embodiment of the invention provides screen means that are adjustable.

In many instances a single, adjustable screen may fulfill a users needs, while in some instances a number of screening provisions may be used.

In the case of a user working primarily under overhead illumination, a fixed screen or screens may fulfill the users needs.

For situations where daylight provides significant illumination, and where both intensity and direction can vary significantly, the need for one or more adjustable screens may arise.

One embodiment of an adjustable screen in accordance with the present invention is both angularly and axially adjustable, for improved screening efficiency, and to afford a degree of retractability when not in use.

In one embodiment, a plurality of the subject screens may be applied to the face of a monitor, such as a computer, to form a hood about the face of the computer screen.

In some circumstances, such as a user sitting facing a window, the screen or screens may be deployed in relation to the user, to shield incident light from the person of the user, which otherwise would be adversely reflected onto the screen of the monitor. In such use, the angular and axial adjustability of a screening embodiment, together with a variety of available mounting modes can enhance the utility of the subject screens.

The present invention provides a screening device for limiting the access of light to a reference device having a viewing reference surface, said screening device having a substantially opaque screening portion of predetermined size and form; and mounting means for securely mounting the device.

The device mounting means may be adjustable, to enable relative displacement between the substantially opaque screening portion and the reference device.

The device screening portion may have a spine portion of predetermined cross-sectional shape; the mounting means having trough means to receive at least a portion of the length of the spine portion in frictionally engaged relation therein.

The screening device spine portion is preferably rotatably and axially displaceable relative to the trough means, to enable repositioning displacement of the screening portion relative to illuminated reference surfaces, in light interception modifying relation therewith.

The screening device mounting means may include an externally accessible adherent surface portion for attachment of the screening device to a support surface such as the monitor screen casing, with a plurality of such adherent surfaces being available.

A pair of such adherent surfaces may be adjoined surfaces extending mutually at right angles to form a channel in back-to-back relation with the trough means

The mounting means may be located in off-set relation with the screening portion.

The screening device spine portion may be of circular section; the trough means enclosing a peripheral portion of the spine portion in close fitting, friction generating relation, to retain the screening portion in a stable, positioned condition.

The screening device spine portion may be of substantially rectangular section; the trough means enclosing edge portions of the spine portion in compressive, friction generating relation, to retain the screening portion in a stable, positioned condition.

The screening device spine portion may be positioned in asymmetrical relation, relative to the plane of the screening portion

The screening device trough means is preferably open-ended to receive the device spine portion in entered relation therein; and to permit it to extend outwardly beyond the trough.

The screening device trough means has an axially extending opening that may be asymmetrically positioned, and of sufficient width to provide a range of angular positions for the screening portion of the device.

The trough means is preferably open at least at one end, to enable relative axial displacement of a portion of the spine portion of the device outside the trough.

While intended primarily for use with desk-top computers, and illustrated in that venue, modified versions employing smaller screen elements may be used in conjunction with a lap top computer, for purposes of privacy as well as shading against incident light and reflections.

In the case of cell phones, a miniature version improves viewing conditions under sunlit conditions and can serve as a screen protector, when folded across the screen.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a front perspective view showing a set of the subject screens mounted to the face of a monitor screen;

FIG. 2 is a top perspective view of an adjustable embodiment of the subject screens, in accordance with the present invention;

FIG. 3 is a side elevation of the FIG. 2 embodiment, in a partially extended condition;

FIG. 4 is an enlarged end view of the bracket portion of the subject screen, showing alternative adhesive attachments;

FIG. 5 is a side perspective view of a basic screening embodiment;

FIG. 6 is a perspective end view of a simple T-bar embodiment;

FIG. 7 is a perspective view of a monitor having the FIG. 6 screening embodiment mounted in place;

FIG. 8 is a plan view of a cranked screening embodiment mounted to a side face of a monitor;

FIG. 9 is a perspective side view of a further embodiment, and

FIG. 10 is a plan view of the FIG. 9 embodiment.

### DETAILED DESCRIPTION OF THE INVENTION

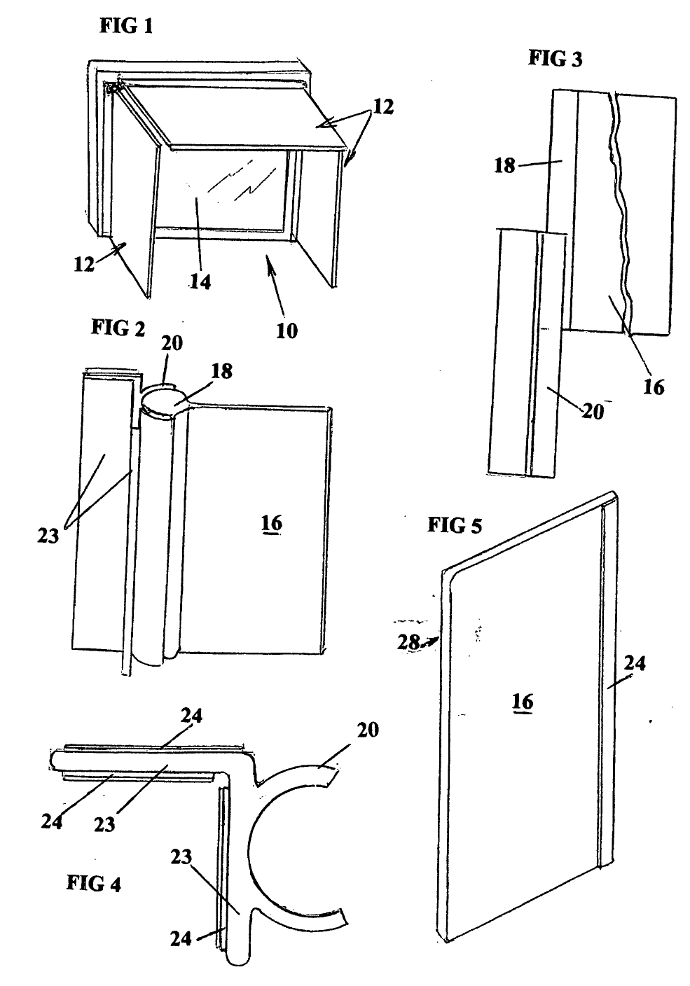

Referring to FIGS. 1 through 4, FIG. 1 shows a screen such as a computer monitor 10 having three screens 12 mounted in shading relation with the screen face 14.

The screens 12 each has a rectangular opaque surface 16 integral with a cylindrical shaft portion 18 that is removably mounted in an elongated support trough 20. The trough 20 has a bracket portion 22 with arms 23. At least one surface of the arms 23 is covered with a pressure sensitive adhesive layer 24 that is protected by way of a strippable release cover 26.

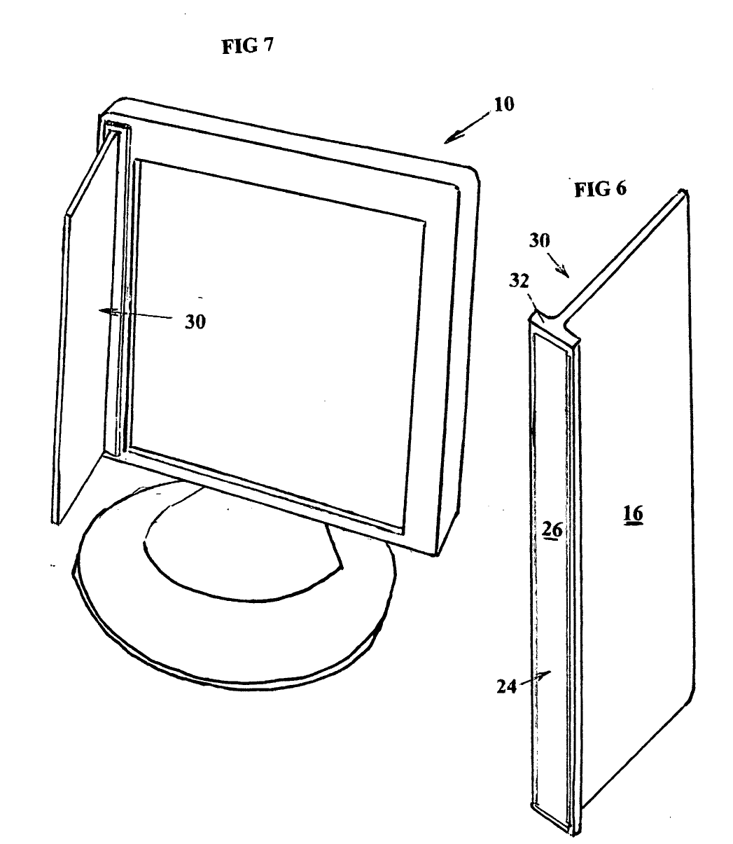

In FIG. 4, three such adhesive layers 24 are shown, to illustrate all possibilities. In practice a single such adhesive layer 24 may be provided, as shown in FIG. 2, The shaft portion 18 is rotatable within the trough 20, and may also be selectively displaced along the trough 20, as shown in FIG. 3, so as to reposition the screen surface 16 axially, relative to the trough 20.

A second embodiment 28, shown in FIG. 5 has a planar opaque portion 16, with a single pressure sensitive adhesive layer 24 applied at one face edge. Inversion of the screen reverses the adhesive layer 24 from being rightward-facing to leftward facing.

Turning to FIGS. 6 and 7, a screen device 30 is of T-form section, the short cross-bar 32 of the T-section forming a support flange, with an adhesive layer 24 and release cover 26 applied to its back face. FIG. 7 shows the screen device 30 adhesively secured to one side of a viewing monitor, such as a computer screen or a television. It will be understood that the cross-bar 32 may be at right-angles, or it may be skewed from the screen surface 16.

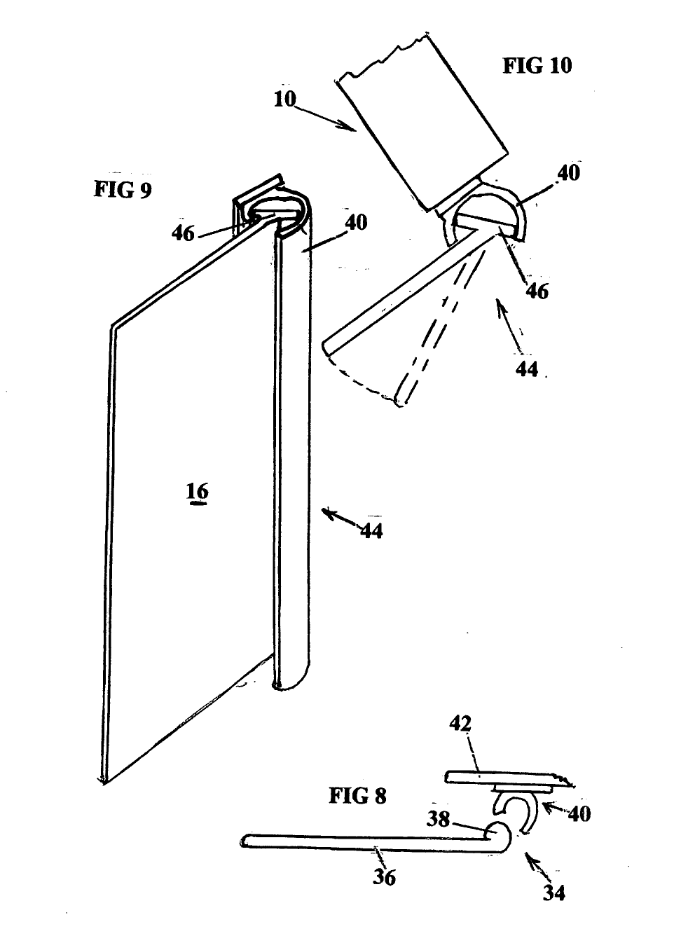

Referring to FIG. 8, a screen device 34 has an opaque screen portion 36 and an off-set cylindrical mounting shaft portion 38 (shown dismounted from its trough 40). The mounting trough portion 40 is illustrated as being attached to a side portion 42 of the device being screened. It will be understood that the pivotal range of positions of the screen portion 36 relative to the trough portion 40 can be changed by the simple expedient of withdrawing the mounting shaft 38 from the trough 40, inverting the screen, and replacing the shaft 38 into the trough 40, for an extended angular location.

FIGS. 9 and 10 show an off-set embodiment 44 having a screen portion 16, and an angularly off-set (skewed) support flange portion 46 pivotally mounted in a mounting trough 40.

It will be understood that the support flange portion and the associated mounting trough can be symmetrical, and need not be off-set, in the manner illustrated.

Adoption of a Tee-form support flange such as flange 46, as compared with a cylindrical mounting shaft, enables the use of a stiffer construction for the associated mounting trough. The Tee-form support flange enables the axial repositioning of the flange 46 along the trough 40, and greatly facilitates the removal and replacement of the support flange portion 46 with the mounting trough 40.

It will be understood by those skilled in the art that the above disclosure is directed primarily to specific embodiments of the present invention, and that the subject invention is susceptible of reduction to practice by persons skilled in the art, in other embodiments that fall within the scope of the appended claims.

1. A screening device for limiting the access of light to a reference device having a viewing reference surface, said screening device having a substantially opaque screening portion of predetermined size and form; and mounting means for securely mounting said device.

2. The screening device as set forth in claim 1, said mounting means being adjustable, to enable relative displacement between said substantially opaque screening portion and said reference device.

3. The screening device as set forth in claim 2, said substantially opaque screening portion having a spine portion of predetermined cross-sectional shape; said mounting means having trough means to receive at least a portion of the length of said spine portion in entered, supported relation therein.

4. The screening device as set forth in claim 3, said spine portion being rotatably and axially displaceable relative to said trough means, to enable repositioning displacement of said screening portion relative to illuminated reference surfaces, in light interception modifying relation therewith.

5. The screening device as set forth in claim 1, said mounting means including an adherent surface portion for attachment to said screening device.

6. The screening device as set forth in claim 3, said trough means having an externally accessible surface having adherent contact means thereon, for attachment to said reference device.

7. The screening device as set forth in claim 6, said trough means having a plurality of externally accessible surfaces, at least one said externally accessible surface having adherent contact means thereon, for attachment to said reference device.

8. The device as set forth in claim 7, said plurality of surfaces having a pair of adjoined surfaces extending mutually at right angles to form a channel in back-to-back relation with said trough means.

9. The screening device as set forth in claim 1, wherein said mounting means are positioned in off-set relation with said screening portion.

10. The screening device as set forth in claim 3, wherein said spine portion is of circular section; said trough means enclosing a peripheral portion of said spine portion in close fitting, friction generating relation, to retain said screening portion in a stable, positioned condition.

11. The screening device as set forth in claim 3, wherein said spine portion is of substantially rectangular section; said trough means enclosing edge portions of said spine portion in compressive, friction generating relation, to retain said screening portion in a stable, positioned condition.

12. The screening device as set forth in claim 3, wherein said spine portion is positioned in asymmetrical relation, relative to the plane of said screening portion

13. The screening device as set forth in claim 10, wherein said spine portion is positioned in asymmetrical, off-set relation, relative to the plane of said screening portion.

14. The screening device as set forth in claim 11, wherein said spine portion is positioned in asymmetrical, off-set relation, relative to the plane of said screening portion.

15. The screening device as set forth in claim 1, said mounting means having trough means to receive a spine portion of said device screening portion in frictionally secured relation therein.

16. The screening device as set forth in claim 15, said trough means having an axially extending opening to receive said spine portion of said device screening portion in entered relation therein.

17. The screening device as set forth in claim 16, wherein said trough means axially extending opening is asymmetrically positioned, and of sufficient width to provide a range of angular positions for said screening portion.

18. The screening device as set forth in claim 16, wherein said trough means is open at one end, to enable relative axial displacement of a portion of said device spine portion outside said trough.

19. The screening device as set forth in claim 3, wherein said spine portion is symmetrically located along one edge of said screening portion.
